(19) United States
(12) Patent Application Publication
(10) Pub. No.: US 2025/0327926 A1
(43) Pub. Date: Oct. 23, 2025

(54) RANGING DEVICE

(71) Applicant: CANON KABUSHIKI KAISHA, Tokyo (JP)

(72) Inventors: TAKURO YAMAMOTO, Kanagawa (JP); SHOGO YAMASAKI, Kanagawa (JP)

(21) Appl. No.: 19/170,605

(22) Filed: Apr. 4, 2025

(30) Foreign Application Priority Data
Apr. 23, 2024 (JP) 2024-069761

(51) Int. Cl. G01S 17/08; G01S 7/481; G01S 7/4865; G01S 17/931

(52) U.S. Cl. CPC G01S 17/08; G01S 7/4815; G01S 7/4816; G01S 7/4865; G01S 17/931

(57) ABSTRACT

A ranging device includes a light emitting element array in which a plurality of light emitting elements, each of which has variable light emission power, are two-dimensionally arranged, a thinning control unit configured to perform thinned-out light emission control such that some of the plurality of light emitting elements emit light and the other light emitting elements do not emit light, and a power control unit configured to control the light emission power of each of the plurality of light emitting elements such that light emission power per unit area does not exceed a threshold based on a first thinning rate indicating a proportion of the light emitting elements that do not emit light among the plurality of light emitting elements.

### BACKGROUND

### Technical Field

The present disclosure relates to a ranging device.

### Description of the Related Art

Japanese Patent Application Laid-Open No. 2023-116280 discloses a ranging device that performs ranging by a light detection and ranging (LiDAR) technology. The ranging device disclosed in Japanese Patent Application Laid-Open No. 2023-116280 includes a surface emitting element array including a plurality of surface emitting elements, and irradiates an object with light. Each of the plurality of surface emitting elements of Japanese Patent Application Laid-Open No. 2023-116280 can be individually switched between a turned-on state and a turned-off state. The ranging device of Japanese Patent Application Laid-Open No. 2023-116280 controls a combination of surface emitting elements to be turned on such that the total amount of energy of light that may enter eyes of a person becomes equal to or less than a preset threshold.

A ranging device that performs ranging by emitting light as disclosed in Japanese Patent Application Laid-Open No. 2023-116280 is required to achieve both eye safety and improvement in ranging performance.

### SUMMARY

An object of the present disclosure is to provide a ranging device capable of improving ranging performance while implementing the eye safety.

According to one disclosure of the present specification, there is provided a ranging device including a light emitting element array in which a plurality of light emitting elements, each of which has variable light emission power, are two-dimensionally arranged, a thinning control unit configured to perform thinned-out light emission control such that some of the plurality of light emitting elements emit light and the other light emitting elements do not emit light, and a power control unit configured to control the light emission power of each of the plurality of light emitting elements such that light emission power per unit area does not exceed a threshold based on a first thinning rate indicating a proportion of the light emitting elements that do not emit light among the plurality of light emitting elements.

According to one disclosure of the present specification, there is provided a ranging device including a light emitting element array in which a plurality of light emitting elements, each of which has variable light emission power, are two-dimensionally arranged, a thinning control unit configured to perform thinned-out light emission control such that some of the plurality of light emitting elements emit light and the other light emitting elements do not emit light, and a power control unit configured to control the light emission power of each of the plurality of light emitting elements. The thinning control unit sets a first thinning rate indicating a proportion of the light emitting elements that do not emit light among the plurality of light emitting elements such that light emission power per unit area does not exceed a threshold based on light emission power of each of the plurality of light emitting elements.

Further features of the present invention will become apparent from the following description of exemplary embodiments with reference to the attached drawings.

### BRIEF DESCRIPTION OF THE DRAWINGS

FIG. 1 is a hardware block diagram illustrating a schematic configuration example of a ranging device according to a first embodiment.

FIG. 2 is a functional block diagram illustrating a schematic configuration example of the ranging device according to the first embodiment.

FIG. 3 is a diagram illustrating an outline of an operation of the ranging device according to the first embodiment in one ranging period.

FIG. 4A, FIG. 4B, FIG. 4C, and FIG. 4D are graphs visually illustrating frequency distributions of light reception count values according to the first embodiment.

FIG. 5A, FIG. 5B, and FIG. 5C are schematic diagrams illustrating thinned-out light emission control of a light emitting element array according to the first embodiment.

FIG. 6 is a flowchart for describing an operation of the ranging device according to the first embodiment.

FIG. 7 is a flowchart for describing an operation of a ranging device according to a second embodiment.

FIG. 8A, FIG. 8C, FIG. 8E, and FIG. 8G are schematic diagrams illustrating thinned-out light emission control of a light emitting element array according to a third embodiment, and FIG. 8B, FIG. 8D, FIG. 8F, and FIG. 8H are schematic diagrams illustrating thinned-out light reception control of a light receiving element array according to the third embodiment.

FIG. 9A is a schematic diagram illustrating thinned-out light emission control of a light emitting element array according to a fourth embodiment, and FIG. 9B is a schematic diagram illustrating thinned-out light reception control of a light receiving element array according to the fourth embodiment.

FIG. 10A and FIG. 10B are block diagrams of equipment according to a fifth embodiment.

### DESCRIPTION OF THE EMBODIMENTS

Hereinafter, embodiments of the present invention will be described with reference to the drawings. The same or corresponding elements are denoted by the same reference numerals throughout the drawings, and the description thereof may be omitted or simplified.

### First Embodiment

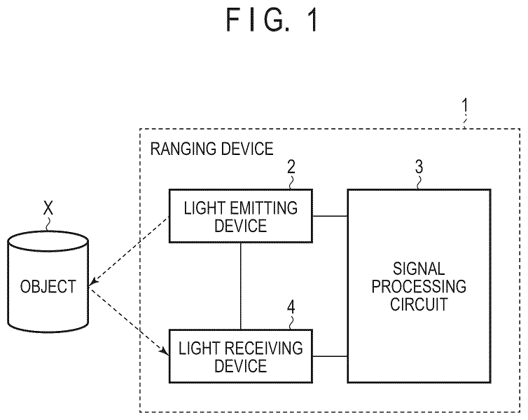

FIG. 1 is a hardware block diagram illustrating a schematic configuration example of a ranging device 1 according to the present embodiment. The ranging device 1 includes a light emitting device 2, a signal processing circuit 3, and a light receiving device 4. The configuration of the ranging device 1 illustrated in the present embodiment is an example, and is not limited to the illustrated configuration.

The ranging device 1 is a device that measures a distance to an object X for which ranging is to be performed by using a technology such as light detection and ranging (LiDAR). The ranging device 1 measures the distance from the ranging device 1 to the object X based on a time difference from when light is emitted from the light emitting device 2 to when reflected light from the object X is received by the light receiving device 4, that is, a time of flight (ToF) of the light.

One of measurement methods using the LiDAR is a direct time of flight (dToF) method. The dToF method is a method in which, for example, an elapsed time from light emission to light reception is directly measured by a time-to-digital converter or the like, and the distance is calculated from the elapsed time and a speed of light.

The light received by the light receiving device 4 includes ambient light such as sunlight in addition to the reflected light from the object X. Therefore, the ranging device 1 performs ranging in which an influence of the ambient light is reduced using a method of repeatedly performing a measurement operation of specifying a period in which the light is incident among a plurality of periods (bin periods) and determining that reflected light is incident in a period in which a light amount is at a peak.

The light emitting device 2 is a device such as a semiconductor laser that emits light to the outside of the ranging device 1. The semiconductor laser can be, for example, a surface emitting laser (VCSEL).

The signal processing circuit 3 can include a control circuit, a counter circuit, a processor that performs arithmetic processing of a digital signal, a memory that stores a digital signal, and the like. The memory can be, for example, a semiconductor memory.

The light receiving device 4 generates a pulse signal including a pulse based on incident light, and counts the pulse signal to generate a light reception count value. The light receiving device 4 is, for example, a photoelectric conversion device including an avalanche photodiode as a photoelectric conversion element. In this case, when one photon is incident on the avalanche photodiode, and charges are generated, one pulse is generated by avalanche multiplication. However, the light receiving device 4 may also use, for example, a photoelectric conversion element using another photodiode.

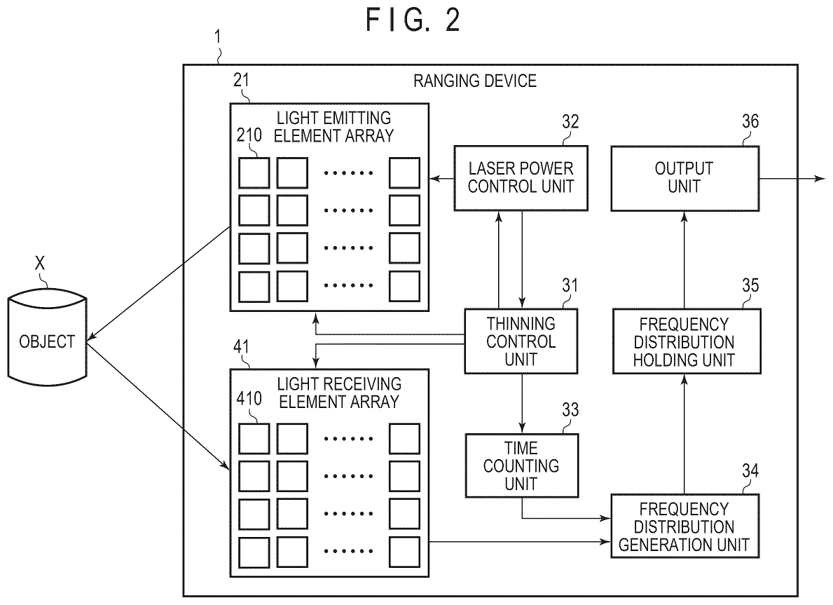

FIG. 2 is a functional block diagram illustrating a schematic configuration example of the ranging device 1 according to the present embodiment. The ranging device 1 includes a light emitting element array 21, a light receiving element array 41, a thinning control unit 31, a laser power control unit 32, a time counting unit 33, a frequency distribution generation unit 34, a frequency distribution holding unit 35, and an output unit 36. The light emitting element array 21 and the light receiving element array 41 correspond to the light emitting device 2 and the light receiving device 4 in FIG. 1, respectively. The thinning control unit 31, the laser power control unit 32, the time counting unit 33, the frequency distribution generation unit 34, the frequency distribution holding unit 35, and the output unit 36 correspond to the signal processing circuit 3 in FIG. 1.

The light emitting element array 21 includes a plurality of light emitting elements 210 two-dimensionally arranged so as to form a plurality of rows and a plurality of columns. Each of the plurality of light emitting elements 210 emits light toward the object X. Each of the plurality of light emitting elements 210 is preferably a laser light source that emits laser light having high straightness. The laser light source may be, for example, a surface emitting laser. In addition, light emission power of each of the plurality of light emitting elements 210 is variable, and the light emission power is controlled by the laser power control unit 32. The light emitted from the light emitting element array 21 is reflected by the object X and is then incident on the light receiving element array 41. In the following description, each of the plurality of light emitting elements 210 is assumed to be a laser element that emits the laser light, but is not limited thereto.

The light receiving element array 41 includes a plurality of light receiving elements 410 two-dimensionally arranged so as to form a plurality of rows and a plurality of columns. Each of the plurality of light receiving elements 410 generates a pulse signal including a pulse based on the incident light, and counts the pulse signal to generate the light reception count value. The light receiving element 410 is, for example, a single photon avalanche diode (SPAD) including an avalanche photodiode, but is not limited thereto.

The thinning control unit 31 performs thinned-out light emission control in the light emitting element array 21 and thinned-out light reception control in the light receiving element array 41. The thinned-out light emission control is an operation of controlling each of the plurality of light emitting elements 210 such that some of the plurality of light emitting elements 210 included in the light emitting element array 21 emit light and the others do not emit the light. The thinned-out light reception control is an operation of controlling each of the plurality of light emitting elements 210 so as to activate some of the plurality of light receiving elements 410 included in the light receiving element array 41 and deactivate the others. A proportion of the light emitting elements 210 that do not emit the light to the total number of the plurality of light emitting elements 210 is referred to as a thinning rate (first thinning rate) of the light emitting element array 21. A proportion of the deactivated light receiving elements 410 to the total number of the plurality of light receiving elements 410 is referred to as a thinning rate (second thinning rate) of the light receiving element array 41. The thinning control unit 31 outputs information indicating the thinning rate of the light emitting element array 21 to the laser power control unit 32. The deactivation of the light receiving element 410 can be performed, for example, by stopping the counting of the pulse signal in the light receiving element 410. Alternatively, in a case where the light receiving element 410 has a function of recharging a potential of the avalanche photodiode, the light receiving element 410 may be deactivated by stopping supply of a recharge pulse or a clock signal.

Furthermore, the thinning control unit 31 controls a start timing of time counting in the time counting unit 33 in synchronization with operation timings of the light emitting element array 21 and the light receiving element array 41. The time counting unit 33 outputs a time count value to the frequency distribution generation unit 34.

The laser power control unit 32 controls laser power of the light emitting element 210 based on information regarding the thinning rate of the light emitting element array 21 acquired from the thinning control unit 31. Here, the laser power is energy of the laser light emitted from the light emitting element 210 per unit time. The laser power control unit 32 controls the laser power of each of the plurality of light emitting elements 210 such that laser power per unit area does not exceed a predetermined threshold based on the information regarding the thinning rate of the light emitting element array 21. The laser power control unit 32 controls the laser power, for example, by controlling electric power supplied to each of the plurality of light emitting elements 210.

The frequency distribution generation unit 34 receives the light reception count value output from each of the plurality of light receiving elements 410 and the time count value output from the time counting unit 33. The frequency distribution generation unit 34 accumulates the light reception count values at predetermined time intervals to generate a frequency distribution in which the time interval and the light reception count value are associated with each other. The frequency distribution holding unit 35 holds the frequency distribution generated by the frequency distribution generation unit 34. The frequency distribution holding unit 35 has a storage capacity for storing the frequency distribution for each of the plurality of light receiving elements 410.

The frequency distribution held in the frequency distribution holding unit 35 can be output as it is as distance information to the outside via the output unit 36. In this case, an external signal processing device performs processing of calculating the distance from the ranging device 1 to the object X based on a peak of the frequency distribution. In addition, the frequency distribution held in the frequency distribution holding unit 35 may be converted into information indicating a distance and output to the outside by the output unit 36. In this case, the output unit 36 performs processing of determining the peak of the frequency distribution, and outputs information indicating a time interval of the peak to the outside in a predetermined output format as the distance information from the ranging device 1 to the object X. In this case, the output unit 36 also functions as a distance calculation unit.

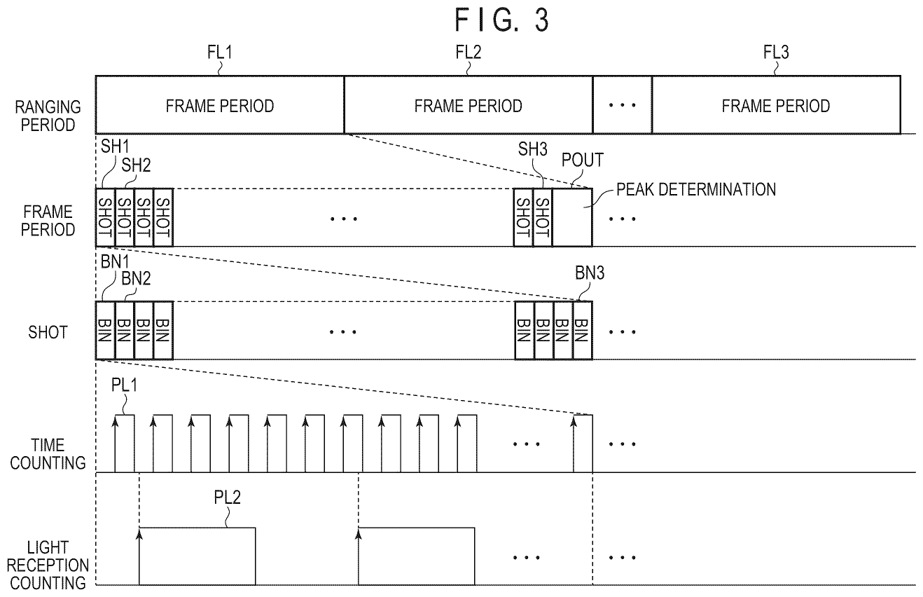

FIG. 3 is a diagram illustrating an outline of an operation of the ranging device 1 according to the present embodiment in one ranging period. The “ranging period” in FIG. 3 indicates a plurality of frame periods FL1, FL2, . . . , and FL3 included in one ranging period. The frame period FL1 indicates a first frame period in one ranging period, the frame period FL2 indicates a second frame period in one ranging period, and the frame period FL3 indicates the last frame period in one ranging period. The frame period is a period in which the ranging device 1 performs ranging once and outputs a result of ranging from the ranging device 1 to the object X as the distance information to the outside once.

In the “frame period” in FIG. 3, a plurality of shots SH1, SH2, . . . , and SH3 and peak determination POUT included in the frame period FL1 are illustrated. The shot is a period in which the light emitting element array 21 performs light emission and the frequency distribution is updated by a light receiving pulse PL2 based on the light emission. The shot SH1 indicates a first shot in the frame period FL1. The shot SH2 indicates a second shot in the frame period FL1. The shot SH3 indicates the last shot in the frame period FL1. The peak determination POUT indicates a period for determining and outputting the ranging result based on peaks obtained by accumulating signals of the plurality of shots. Although FIG. 3 illustrates an example in which the peak determination is performed once at the end of the frame period, the peak determination may be performed after the processing of each shot, or the peak determination may be performed every time the processing of the shot is performed a predetermined number of times.

In the “shot” in FIG. 3, a plurality of bins BN1, BN2, . . . , and BN3 included in the shot SH1 are illustrated. The “bin” indicates one time interval (bin period) in which a series of pulse counts is performed. The bin BN1 indicates the first bin in the shot SH1. The bin BN2 indicates the second bin in the shot SH1. The bin BN3 indicates the last bin in the shot SH1. The peak determination may be performed after each bin period elapses, or the peak determination may be performed every time a predetermined number of bin periods elapse.

“Time counting” in FIG. 3 schematically illustrates a temporal change of the time count value generated in the time counting unit 33. As illustrated in FIG. 3, the time counting unit 33 increments the time count value for each time interval of the bin according to the passage of time. Therefore, the time count value is a parameter indicating a bin number. A time count pulse PL1 in FIG. 3 indicates a pulse for incrementing the time count value.

“Light reception counting” in FIG. 3 schematically illustrates the light receiving pulse PL2 based on an incident photon in the bin BN1. As illustrated in FIG. 3, when a rising edge of the light receiving pulse PL2 appears, the light reception count value increments by 1. As a result, the number of photons detected within the bin period is acquired as the light reception count value. When one bin period elapses and shift to the next bin period is made, the light reception count value is reset to zero.

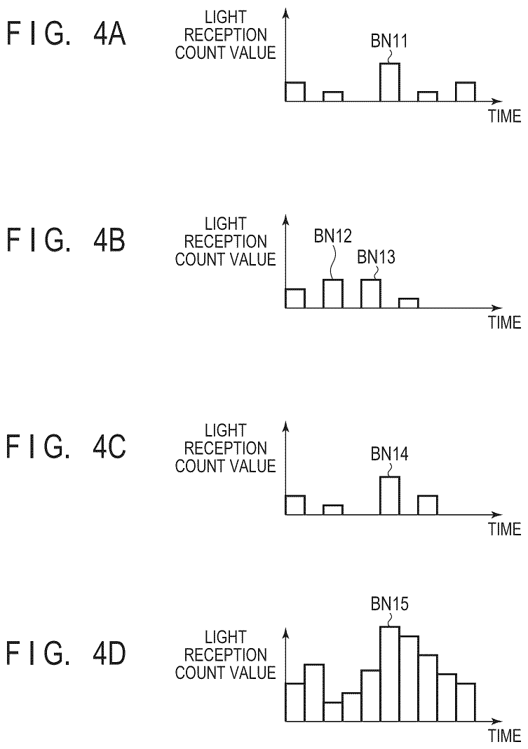

FIGS. 4A to 4D are graphs visually illustrating frequency distributions of the light reception count values generated by the frequency distribution generation unit 34. In the present specification, the frequency distribution is information in which the light reception count value is associated with each time interval, and is not necessarily visually displayed. FIGS. 4A, 4B, and 4C illustrate examples of the frequency distributions of the light reception count values (corresponding to the number of incident photons) in the first shot, the second shot, and the third shot, respectively. FIG. 4D illustrates an example of the frequency distribution in which the light reception count values of all the shots are accumulated. A horizontal axis represents an elapsed time from light emission. One section of the frequency distribution corresponds to one bin period in which photon detection is performed. A vertical axis represents the light reception count value acquired in each bin period.

As illustrated in FIG. 4A, in the first shot, the photons are incident in five bin periods. In the first shot, since a bin BN11 which is the sixth bin has the largest light reception count value, the bin BN11 is the peak. As illustrated in FIG. 4B, in the second shot, the photons are incident in four bin periods. In the second shot, since a bin BN12 which is the third bin and a bin BN13 which is the fifth bin have the largest light reception count value, the bins BN12 and BN13 are the peaks. As illustrated in FIG. 4C, also in the third shot, the photons are incident in four bin periods. In the third shot, since a bin BN14 which is the sixth bin has the largest light reception count value, the bin BN14 is the peak. As described above, in the examples of FIGS. 4A to 4C, the number of incident photons and an incidence time are different for each shot. The frequency distributions can include not only the light reception count value of the light reflected from the object X but also the light reception count value of the ambient light other than the reflected light. Therefore, different bins may be detected as the peaks for each shot, as illustrated in FIGS. 4A to 4C.

As illustrated in FIG. 4D, in the frequency distribution in which the light reception count values of all the shots are accumulated, the number of photons of a bin BN15 which is the sixth bin is the maximum, and thus, the bin BN15 is the peak. In the peak determination POUT in FIG. 3, the peak of the frequency distribution after the accumulation is determined, and time information of the bin corresponding to the peak is output. The time information indicates a time of flight of the light emitted from the light emitting element array 21 and reflected by the object X, and can be used to calculate the distance between the ranging device 1 and the object X.

By accumulating the light reception count values of the plurality of shots, it is possible to more accurately detect a bin that is likely to have the light reception count value of the reflected light from the object X even in a case where the light reception count value of the ambient light can be included. Therefore, even in a case where the light emitted from the light emitting element array 21 is weak, the ranging can be performed with high accuracy by adopting processing of repeating the plurality of shots and accumulating the light reception count values of the plurality of shots.

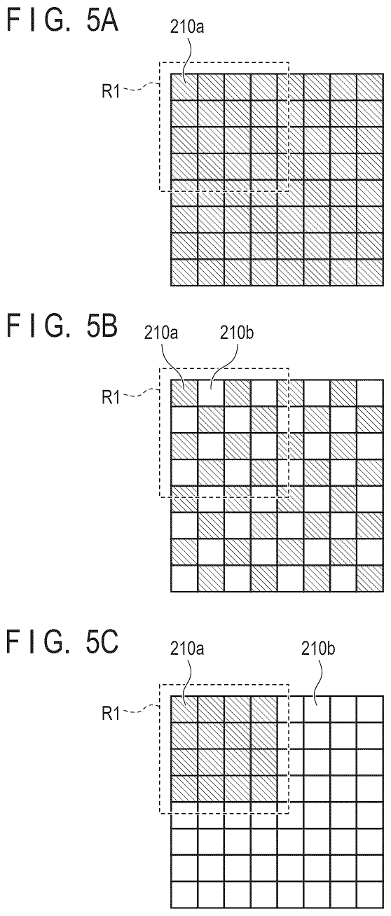

A relationship between the thinned-out light emission control in the light emitting element array 21 and eye safety will be described with reference to FIGS. 5A, 5B, and 5C. FIGS. 5A, 5B, and 5C are schematic diagrams illustrating the thinned-out light emission control of the light emitting element array 21 according to the present embodiment. FIGS. 5A, 5B, and 5C illustrate light emission states of the plurality of light emitting elements 210 and an opening range in the light emitting element array 21. A hatched light emitting element 210a indicates the light emitting element 210 in a light emitting state, and an unhatched light emitting element 210b indicates the light emitting element 210 in a non-light emitting state. An opening range R1 is a reference range used for determination of a laser intensity per unit area in laser product eye safety standards, and corresponds to a region of human eyes. In practice, the reference range can be circular, but in FIGS. 5A to 5C, the opening range R1 is indicated by a square for simplification of description.

FIG. 5A schematically illustrates a case where the thinned-out light emission control of the light emitting element array 21 is not performed, that is, a state in which the entire surface of the light emitting element array 21 emits light. As illustrated in FIG. 5A, in the opening range R1, all of 16 light emitting elements 210a are in the light emitting state.

FIG. 5B schematically illustrates arrangement of the light emitting elements 210a and 210b in a case where the thinned-out light emission control of the light emitting element array 21 is performed at a thinning rate of ½. In the example of FIG. 5B, in each row and each column, the light emitting element 210a in the light emitting state and the light emitting element 210b in the non-light emitting state are alternately arranged. That is, the light emitting element 210a in the light emitting state and the light emitting element 210b in the non-light emitting state form a checker pattern. As illustrated in FIG. 5B, in the opening range R1, eight light emitting elements 210a out of 16 light emitting elements are in the light emitting state, and the remaining eight light emitting elements 210b are in the non-light emitting state. The arrangement of the light emitting elements 210a in the light emitting state and the light emitting elements 210b in the non-light emitting state can be appropriately changed according to the thinning rate. That is, a plurality of light emitting elements 210a in the light emitting state may be continuously arranged, and a plurality of light emitting elements 210b in the non-light emitting state may be continuously arranged. The thinned-out light reception control of the light receiving element array 41 can also be performed in the same manner as in FIG. 5B according to the thinning rate.

FIG. 5C schematically illustrates the arrangement of the light emitting elements 210a and 210b in a case where control is performed to narrow a light emitting range so as to concentrate the light emitting elements 210a in the light emitting state in the opening range R1. In the example of FIG. 5C, the light emitting element 210a in the light emitting state is arranged in the opening range R1, and the light emitting element 210b in the non-light emitting state is arranged outside the opening range R1.

Here, for example, the laser power of one light emitting element is assumed to be α (mW). At this time, the laser power per unit area is calculated by (the laser power α of one light emitting element)×(the number of light emitting elements per unit area). Therefore, laser power per unit area of the opening range R1 is calculated by (the laser power α of one light emitting element)×(the number of light emitting elements in the opening range R1). Meanwhile, a threshold of the laser power that satisfies eye safety regulations is assumed to be 20 times α, that is, 20α.

Since the number of light emitting elements in the opening range R1 in a situation of FIG. 5A is 16, the laser power in the opening range R1 is 16α, which is equal to or less than the threshold. On the other hand, the number of light emitting elements in the opening range R1 in a situation of FIG. 5B is eight by thinning at a thinning rate of 1/2. Therefore, the laser power in the opening range R1 is 8α, which is also equal to or less than the threshold. Furthermore, even in a case where the laser power of one light emitting element is increased twice in the situation of FIG. 5B, that is, even in a case where the laser power of one light emitting element is 2α, the laser power in the opening range R1 is 16α and is maintained to be equal to or less than the threshold. Therefore, by performing the thinned-out light emission control, it is possible to perform control such that the laser power per unit area of the opening range R1 does not exceed the threshold even when the laser power of one light emitting element is increased.

In addition, since the number of light emitting elements in the opening range R1 in a situation of FIG. 5C is 16, the laser power in the opening range R1 is 16α similarly to the situation of FIG. 5A. Although the laser power is equal to or less than the threshold, when the laser power of one light emitting element is increased twice, the laser power in the opening range R1 exceeds the threshold. Therefore, it is necessary to narrow a light emitting area in the opening range R1 to half or less in order to increase the laser power of one light emitting element twice while satisfying the eye safety regulations in the situation of FIG. 5C. This method imposes a constraint condition that the light emitting range needs to be narrowed to an area that is half or less of the opening range R1, and thus, the degree of freedom in setting of the light emitting range is reduced. On the other hand, the thinned-out light emission control as illustrated in FIG. 5B is effective in a case where it is desired to roughly acquire the distance information within the light emitting range although a spatial resolution of the ranging result is decreased.

As can be seen from the above description, the thinned-out light emission control as illustrated in FIG. 5B is suitable from the viewpoint of the eye safety, a ranging range, and the laser power. In addition, when the laser power is increased, an intensity of the reflected light is also increased, and the peak can be detected even when the number of shots in one frame period is reduced. As a result, a frame rate can be increased, and thus, the thinned-out light emission control as illustrated in FIG. 5B is suitable also from the viewpoint of the frame rate.

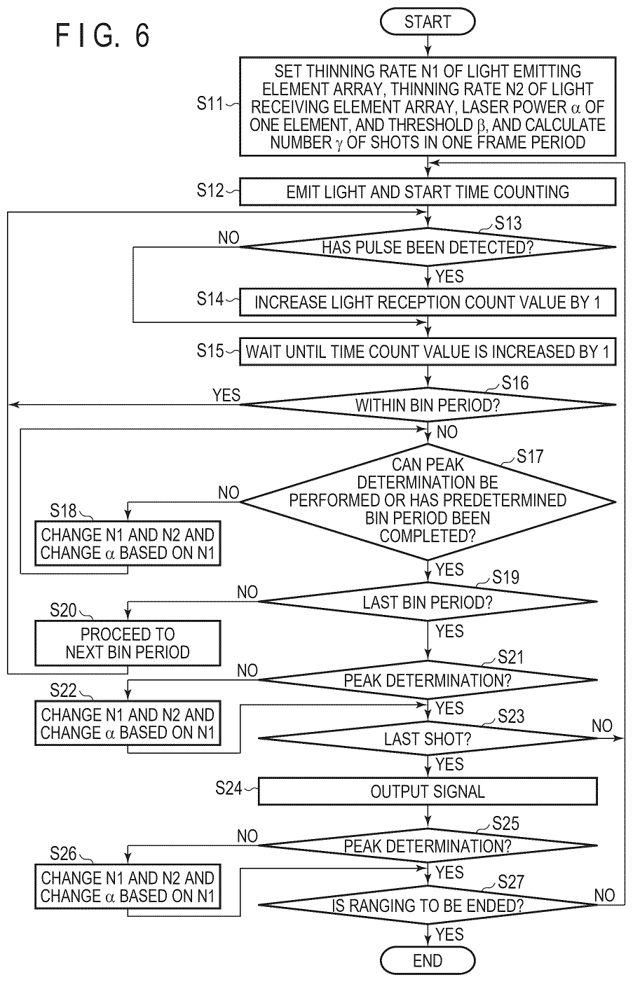

FIG. 6 is a flowchart for describing an operation of the ranging device 1 according to the present embodiment. FIG. 6 illustrates an operation from the start to the end of the ranging period. In the example of FIG. 6, it is assumed that the peak determination POUT in FIG. 3 is performed not only after the processing of the last shot but also after the processing of each shot and after completion of a predetermined bin period.

In step S11, the thinning control unit 31 sets a thinning rate N1 of the light emitting element array 21 and a thinning rate N2 of the light receiving element array 41. The light emitting element 210 that emits light and the light emitting element 210 that does not emit light in the light emitting element array 21 are determined according to the thinning rate N1 set by the thinning control unit 31. Furthermore, the light receiving element 410 to be activated and the light receiving element 410 to be deactivated in the light receiving element array 41 are determined according to the thinning rate N2 set by the thinning control unit 31.

Since step S11 is a scene of setting initial conditions of ranging, the thinning rates N1 and N2 can be set to zero (no thinning), for example. However, in a case where it is known in advance that the distance from the ranging device 1 to the object X is short, or the like, the thinning rates N1 and N2 may be set to values larger than zero, for example, ½.

In step S11, the laser power control unit 32 sets the laser power α per light emitting element 210 and a threshold β of the laser power per unit area. The laser power α per light emitting element 210 can be set based on the thinning rate N1 such that the laser power per unit area does not exceed the threshold β. The thinning control unit 31 determines the number γ of shots in one frame period based on the thinning rates N1 and N2 and the laser power α. The number γ of shots can be determined based on a table in which a correspondence between ranges of the thinning rates N1 and N2 and the laser power α and the number γ of shots is defined.

The parameters set in step S11 can be appropriately set according to a state of the object X, a ranging scene, and the like. The above description is an example in which the number γ of shots is determined from the thinning rates N1 and N2 and the laser power α, but the number γ of shots may be determined first, and the thinning rates N1 and N2 or the laser power α may be determined based on the number γ of shots. For example, in a scene where the object X is moving at a high speed, it is desired to improve the frame rate, and thus the number γ of shots may be set first. In addition, in an environment where strong sunlight is incident on the light receiving element array 41, the influence of the ambient light may be reduced by setting the laser power α first.

The threshold β of the laser power is desirably set so as to satisfy radiation safety standards for laser products. Specifically, the threshold β can be set so as to satisfy Class 1 of IEC 60825-1 of the International Electrotechnical Commission (IEC). Alternatively, the threshold β can be set so as to satisfy Class 1 of JIS C 6802 of the Japanese Industrial Standards (JIS). Alternatively, the threshold β may be set so as to satisfy Class 1 of EN 60825-1 of the European Standards. As described above, the threshold β of the laser power may be set so as to satisfy at least one of various radiation safety standards for laser products.

In step S12, the light emitting element array 21 emits light to the ranging range. At the same time, the time counting unit 33 starts time counting. As a result, signal acquisition processing of one shot is started. The thinning control unit 31 controls the light emission of the light emitting element array 21 and the start of time counting by the time counting unit 33 so as to be synchronized with each other. As a result, an elapsed time from the light emission can be counted. The light receiving element array 41 receives light including the reflected light from the object X. Each of the plurality of light receiving elements 410 of the light receiving element array 41 converts the incident light into the pulse signal by photoelectric conversion. A rising edge of the pulse indicates that the photon is incident on the photoelectric conversion element.

In step S13, in a case where the light receiving element 410 has detected the rising edge of the pulse (YES in step S13), the processing proceeds to step S14. In a case where the light receiving element 410 has not detected the rising edge of the pulse (NO in step S13), the processing proceeds to step S15.

In step S14, the frequency distribution generation unit 34 increases the light reception count value corresponding to the light receiving element 410 for which the rising edge of the pulse has been detected by 1. Then, the processing proceeds to step S15.

In step S15, the ranging device 1 waits until the time count value in the time counting unit 33 is increased by 1. The counting of the time by the time counting unit 33 is started from zero. The time counting can be performed, for example, by incrementing a clock signal generated using a ring oscillator and oscillating at a high speed and at a constant cycle. In a case where a cycle of the clock signal is 0.1 microseconds, when the time count value is increased from 0 to 10 according to the time counting, it can be detected that an elapsed time is 1 microsecond. In the present embodiment, as illustrated in FIG. 3, it is assumed that the clock signal for time counting is set such that the cycle of the time counting is sufficiently shorter than a frequency of the light reception counting.

In step S16, in a case where a current time indicated by the current time count value is before a completion time of a bin period being processed (NO in step S16), the processing proceeds to step S13 and pulse detection is continued. In a case where the current time is after the bin period being processed (YES in step S16), the processing proceeds to step S17, and processing of one clock cycle ends. As described above, a light receiving operation of one clock cycle is performed by the loop from step S13 to step S16.

In step S17, in a case where the peak cannot be determined before the predetermined bin period in one shot is completed (NO in step S17), the processing proceeds to step S18. In a case where the peak can be determined before the predetermined bin period in one shot is completed or in a case where the predetermined bin period in one shot is completed (YES in step S17), the processing proceeds to step S19.

In step S18, the thinning control unit 31 changes the thinning rate N1 of the light emitting element array 21 and the thinning rate N2 of the light receiving element array 41. The thinning control unit 31 outputs information regarding the changed thinning rate N1 to the laser power control unit 32. The laser power control unit 32 changes the laser power α per light emitting element 210 based on the thinning rate N1. The laser power α can be set based on the changed thinning rate N1 such that the laser power per unit area does not exceed the threshold β. For example, in a case where the thinning rate N1 is changed to a larger value and the proportion of the light emitting elements 210 in the non-light emitting state is increased, the laser power control unit 32 increases the laser power α such that the laser power per unit area does not exceed the threshold β. Thereafter, the processing proceeds to step S17. One or more predetermined bin periods in the processing of step S17 are designated in advance, and the processing of steps S17 and S18 can be repeated as many times as the number of designated bin periods.

In step S19, in a case where the current time indicated by the current time count value is before a completion time of the last bin period of the shot being processed (NO in step S19), the processing proceeds to step S20. In step S20, the ranging device 1 performs switching processing for shifting to the next bin period. The switching processing may include resetting of the light reception count value. Thereafter, the processing proceeds to step S13, and the pulse detection is continued. In a case where the current time is after the last bin period of the shot being processed (YES in step S19), the processing proceeds to step S21, and processing of one bin period ends. As described above, the light receiving operation of one shot is performed by the loop from step S13 to step S19.

In step S21, in a case where the peak cannot be determined from the frequency distribution after completion of the last bin period (NO in step S21), the processing proceeds to step S22. In a case where the peak can be determined from the frequency distribution after the completion of the last bin period (YES in step S21), the processing proceeds to step S23.

In step S22, the thinning control unit 31 and the laser power control unit 32 change the thinning rates N1 and N2 and the laser power α by the same processing as in step S18. In the processing of step S22, the number γ of shots in one frame period may be further changed. For example, by reducing the number γ of shots, a processing time can be shortened in the middle of one frame period, and the frame rate can be improved.

In step S23, in a case where the current time indicated by the current time count value is before a completion time of the last shot (NO in step S23), the processing proceeds to step S12, and the processing of the next shot is performed. In a case where the current time indicated by the current time count value is after the completion time of the last shot (YES in step S23), the processing proceeds to step S24, and processing of one shot ends. In this manner, a light emitting operation and the light receiving operation of one shot are performed by the loop from step S12 to step S23.

In step S24, the output unit 36 outputs the frequency distribution or peak information held in the frequency distribution holding unit 35 to the outside of the ranging device 1.

In step S25, in a case where the peak cannot be determined from the frequency distribution after completion of the last shot (NO in step S25), the processing proceeds to step S26. In a case where the peak can be determined from the frequency distribution after the completion of the last shot (YES in step S25), the processing proceeds to step S27.

In step S26, the thinning control unit 31 and the laser power control unit 32 change the thinning rates N1 and N2 and the laser power α by the same processing as in step S18. Also in the processing of step S26, the number γ of shots in one frame period may be further changed. For example, by reducing the number γ of shots, the processing time can be shortened and the frame rate from the next frame period can be improved.

In step S27, the ranging device 1 determines whether or not to end the ranging. In a case where it is determined that the ranging is to be ended (YES in step S27), the processing ends. In a case where it is determined that the ranging is not to be ended (NO in step S27), the processing proceeds to step S12, the light reception count value is reset, and the ranging in the next frame period is started. The determination may be based on, for example, a control signal from equipment on which the ranging device 1 is mounted.

The parameter change processing in steps S17 and S18, the parameter change processing in steps S21 and S22, and the parameter change processing in steps S25 and S26 are merely examples of timings at which the steps of parameter change processing can be performed, and are not essential. For example, a modification can be made such that any one of the parameter change processing in steps S17 and S18, the parameter change processing in steps S21 and S22, and the parameter change processing in steps S25 and S26 is performed.

In addition, in the description of FIG. 6, one light emitting element 210 and one light receiving element 410 are focused for simplification, but the processing can be performed in parallel in a plurality of light emitting elements 210 and a plurality of light receiving elements 410.

According to the present embodiment, the eye safety is ensured by the thinned-out light emission control of the light emitting element array 21. In addition, when performing the thinned-out light emission control, the laser power α per light emitting element 210 can be controlled to a sufficient value according to the thinning rate N1. As a result, emitted light can reach a longer distance as compared with a case where the thinned-out light emission control is performed in a state where the laser power α is kept constant, so that a distance range for which ranging can be performed can be expanded. In addition, since a light reception probability for the reflected light is increased as compared with a case where the thinned-out light emission control is performed in a state where the laser power α is kept constant, the peak determination can be performed early, and the frame rate can be improved. Therefore, according to the present embodiment, the ranging device capable of improving ranging performance while implementing the eye safety is provided.

In the present embodiment, a ranging method in which the time counting unit 33 performs the time counting has been exemplified, but the ranging method is not limited thereto. For example, a ranging method in which an exposure period is controlled such that a light receiving element receives reflected light only at a time interval at which the light reflected by an object at a predetermined distance is incident on the light receiving element, and the exposure period is shifted to perform measurement a plurality of times, and a frequency distribution is generated may be applied.

The thinning rate N1 of the light emitting element array 21 and the thinning rate N2 of the light receiving element array 41 can be, for example, the same as each other. In this case, even when the thinned-out light emission control and the thinned-out light reception control are performed, a correspondence between the light emitting element 210 and the light receiving element 410 can be maintained, so that a processing procedure can be simplified.

On the other hand, the thinning rate N1 of the light emitting element array 21 and the thinning rate N2 of the light receiving element array 41 may be different from each other. In this case, the thinned-out light emission control and the thinned-out light reception control can be performed with a high degree of freedom. However, in a case where the thinning rate N1 of the light emitting element array 21 and the thinning rate N2 of the light receiving element array 41 are different from each other, control is performed to adjust a projection position and a projection range by a projection optical system such that the light emitting range of one light emitting element 210 includes light receiving ranges of one or more light receiving elements.

Furthermore, the thinned-out light reception control of the light receiving element array 41 is not essential. For example, a control method in which the thinned-out light reception control is performed on the light emitting element array 21 at a predetermined thinning rate N1, the laser power α is increased, and the thinned-out light reception control is not performed on the light receiving element array 41 may be applied. In this case, it is possible to expand the distance range for which ranging can be performed without reducing the spatial resolution on a light receiving element array 41 side.

### Second Embodiment

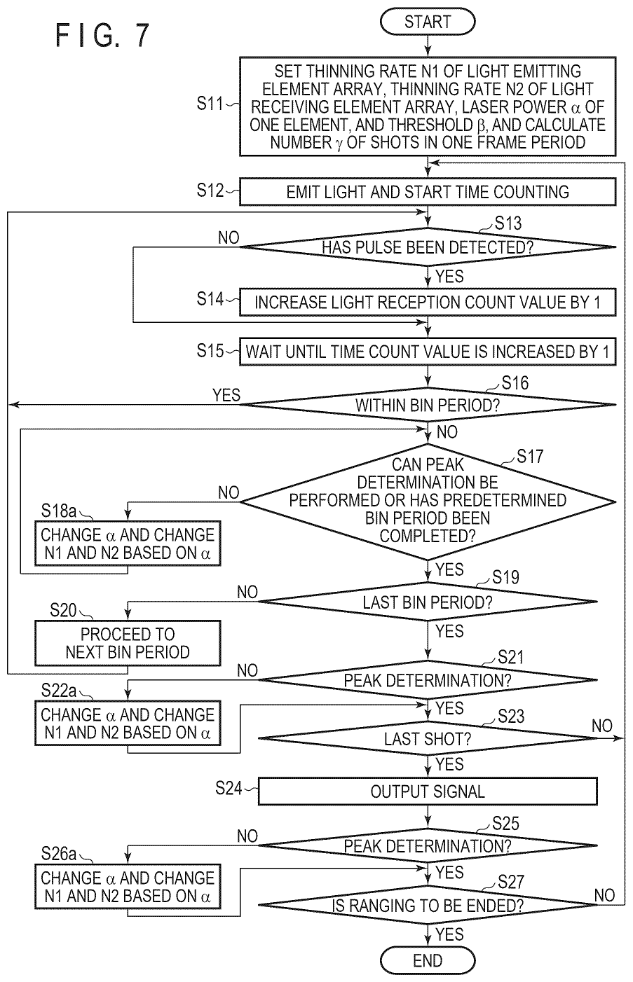

A modified example of the method of setting the thinning rates N1 and N2 and the laser power α described in the first embodiment will be described as a second embodiment. FIG. 7 is a flowchart for describing an operation of a ranging device 1 according to the present embodiment. In the present embodiment, steps S18, S22, and S26 of the first embodiment are replaced with steps S18a, S22a, and S26a, respectively. In addition, in the present embodiment, an order of determining parameters in initial setting of step S11 is different from that of the first embodiment. In the present embodiment, a description of elements common to the first embodiment may be omitted or simplified.

In step S11, a laser power control unit 32 sets laser power α per light emitting element 210 and a threshold β of laser power per unit area. Then, a thinning control unit 31 sets a thinning rate N1 of a light emitting element array 21 and a thinning rate N2 of a light receiving element array 41. Here, the thinning rate N1 of the light emitting element array 21 can be set based on the laser power α per light emitting element 210 such that the laser power per unit area does not exceed the threshold β.

In step S18a, the laser power control unit 32 changes the laser power α per light emitting element 210. The laser power control unit 32 outputs information regarding the changed laser power α to the thinning control unit 31. The thinning control unit 31 changes the thinning rate N1 of the light emitting element array 21 and the thinning rate N2 of the light receiving element array 41 based on the changed laser power α. The thinning rate N1 can be set based on the changed laser power α such that the laser power per unit area does not exceed the threshold β. For example, in a case where the laser power α is changed to a larger value, the thinning control unit 31 changes the thinning rate N1 of the light emitting element array 21 to a larger value, increases a proportion of the light emitting elements 210 in a non-light emitting state, and prevents the laser power per unit area from exceeding the threshold β.

In steps S22a and S26a, the thinning control unit 31 and the laser power control unit 32 change the thinning rates N1 and N2 and the laser power α by the same processing as in step S18a. In the processing of steps S22a and S26a, the number γ of shots in one frame period may be further changed. For example, by reducing the number γ of shots, a processing time can be shortened and a frame rate can be improved.

In the present embodiment, similarly to the first embodiment, the ranging device capable of improving the ranging performance while implementing the eye safety is provided.

### Third Embodiment

In the present embodiment, a case where a light emitting range of one light emitting element 211 is larger than a light receiving range of one light receiving element 411 will be described. In the present embodiment, a description of elements common to the first embodiment or the second embodiment may be omitted or simplified.

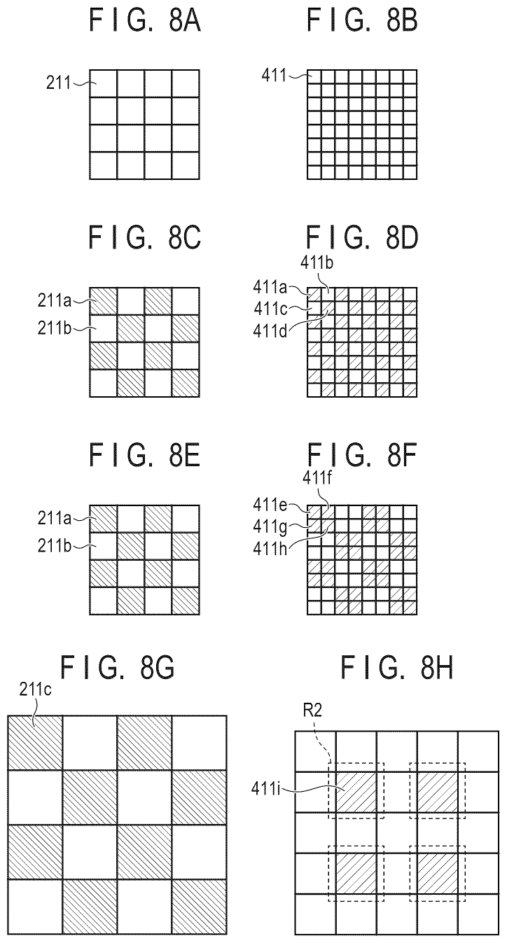

FIGS. 8A, 8C, 8E, and 8G are schematic diagrams illustrating thinned-out light emission control of a light emitting element array 21 according to the present embodiment. FIGS. 8B, 8D, 8F, and 8H are schematic diagrams illustrating thinned-out light reception control of the light receiving element array 41.

FIGS. 8A and 8B schematically illustrate the light emitting range of the light emitting element 211 of the light emitting element array 21 and the light receiving range of the light receiving element 411 of the light receiving element array 41, respectively. One box in FIG. 8A indicates the light emitting range of one light emitting element 211. One box in FIG. 8B indicates the light receiving range of one light receiving element 411. As illustrated in FIGS. 8A and 8B, the light emitting range of one light emitting element 211 is larger than the light receiving range of the light receiving element 411. In the examples of FIGS. 8A to 8F, the area of the light emitting range of one light emitting element 211 is assumed to be four times the area of the light receiving range of one light receiving element 411, but the present invention is not limited thereto. For example, the area of the light emitting range of one light emitting element 211 may be an integral multiple of the area of the light receiving range of one light receiving element 411. That is, the light emitting range of one light emitting element 211 can correspond to the light receiving ranges of m light receiving elements 411 (m is an integer of 2 or more).

In FIGS. 8C, 8E, and 8G, hatched light emitting elements 211a and 211c indicate the light emitting elements 211 in a light emitting state, and an unhatched light emitting element 211b indicates the light emitting element 211 in a non-light emitting state. In FIGS. 8D, 8F, and 8H, hatched light receiving elements 411a and 411d to 411i indicate the light receiving elements 411 that are activated. Unhatched light receiving elements 411b and 411c indicate the light receiving elements 411 that are deactivated.

FIG. 8C schematically illustrates arrangement of the light emitting elements 211a and 211b in a case where the thinned-out light emission control of the light emitting element array 21 is performed at a thinning rate of ½. In the example of FIG. 8C, in each row and each column, the light emitting element 211a in the light emitting state and the light emitting element 211b in the non-light emitting state are alternately arranged.

FIG. 8D schematically illustrates arrangement of the light receiving elements 411a, 411b, 411c, and 411d in a case where the thinned-out light reception control of the light receiving element array 41 is performed at a thinning rate of ½. In the example of FIG. 8D, in each row and each column, the activated light receiving element and the deactivated light receiving element are alternately arranged.

In the examples of FIGS. 8C and 8D, similarly to the first embodiment, the ranging device capable of improving the ranging performance while implementing the eye safety is provided.

FIGS. 8E and 8F illustrate modified examples in which arrangement in the thinned-out light reception control is different. The thinned-out light emission control of FIG. 8E is the same as that of FIG. 8C.

FIG. 8F illustrates a modified example of the arrangement of the light receiving elements in a case where the thinned-out light reception control of the light receiving element array 41 is performed at a thinning rate of ½. In the example of FIG. 8F, all of four light receiving elements 411e, 411f, 411g, and 411h adjacent in a row direction and a column direction are activated. As a result, the light receiving ranges of the light receiving elements 411e, 411f, 411g, and 411h are included in the light emitting range of the light emitting element 211a.

In the example of FIG. 8F, the number of light receiving elements included in the light receiving range corresponding to the light emitting range is twice of that of the example of FIG. 8D. As a result, an effect of expanding a distance range for which ranging can be performed or improving a frame rate can be improved. In addition, light reception count values of the four light receiving elements may be added in the light receiving element array 41, and in this case, an effect of improving accuracy of peak determination or shortening a time required for the peak determination can be obtained.

FIGS. 8G and 8H illustrate a modified example in a case where the area of the light emitting range of one light emitting element 211 is not an integral multiple of the area of the light receiving range of the light receiving element 411. In the present modified example, a projection optical system performs control to adjust a projection position and a projection range such that the light emitting range of one light emitting element 210 includes the light receiving ranges of one or more light receiving elements 411. A projection region R2 in FIG. 8H indicates a position and a range where light emitted from the light emitting element 211c is projected. As illustrated in FIG. 8H, the projection region R2 includes the light receiving range of a light receiving element 411i.

In the present embodiment, similarly to the first embodiment, the ranging device capable of improving the ranging performance while implementing the eye safety is provided.

### Fourth Embodiment

In the present embodiment, a case where a light emitting range of one light emitting element 211 is smaller than a light receiving range of one light receiving element 411 will be described. In the present embodiment, a description of elements common to the first to third embodiments may be omitted or simplified.

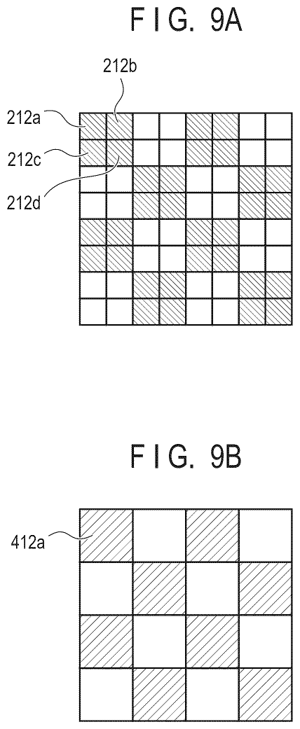

FIG. 9A is a schematic diagram illustrating thinned-out light emission control of a light emitting element array 21 according to the present embodiment. FIG. 9B is a schematic diagram illustrating thinned-out light reception control of a light receiving element array 41.

One box in FIG. 9A indicates the light emitting range of one light emitting element, and one box in FIG. 9B indicates the light receiving range of one light receiving element. As illustrated in FIGS. 9A and 9B, the light emitting range of one light emitting element is smaller than the light receiving range of the light receiving element. In the examples of FIGS. 9A and 9B, the area of the light receiving range of one light receiving element is four times the area of the light emitting range of one light emitting element, but the present invention is not limited thereto. For example, the area of the light receiving range of one light receiving element may be an integral multiple of the area of the light emitting range of one light emitting element. That is, the light receiving range of one light receiving element can correspond to the light emitting ranges of n light emitting elements (n is an integer of 2 or more).

In FIG. 9A, hatched light emitting elements 211a, 211b, 211c, and 211d indicate the light emitting elements in a light emitting state, and an unhatched light emitting element indicates the light emitting element in a non-light emitting state. In FIG. 9B, a hatched light receiving element 412a indicates the light receiving element that is activated, and an unhatched light receiving element indicate the light receiving element that is deactivated.

FIG. 9A illustrates a modified example of arrangement of the light emitting elements in a case where the thinned-out light emission control of the light emitting element array 21 is performed at a thinning rate of ½. In the example of FIG. 9A, all of four light emitting elements 212a, 212b, 212c, and 212d adjacent in a row direction and a column direction emit light. As a result, the light receiving range of the light receiving element 412a is included in a light emitting range obtained by combining those of the four light emitting elements 212a, 212b, 212c, and 212d.

Similarly to the examples of FIGS. 8G and 8H, a projection optical system may adjust a projection position and a projection range such that the light emitting range of one light emitting element includes the light receiving ranges of one or more light receiving elements.

In the present embodiment, similarly to the first embodiment, the ranging device capable of improving the ranging performance while implementing the eye safety is provided.

### Fifth Embodiment

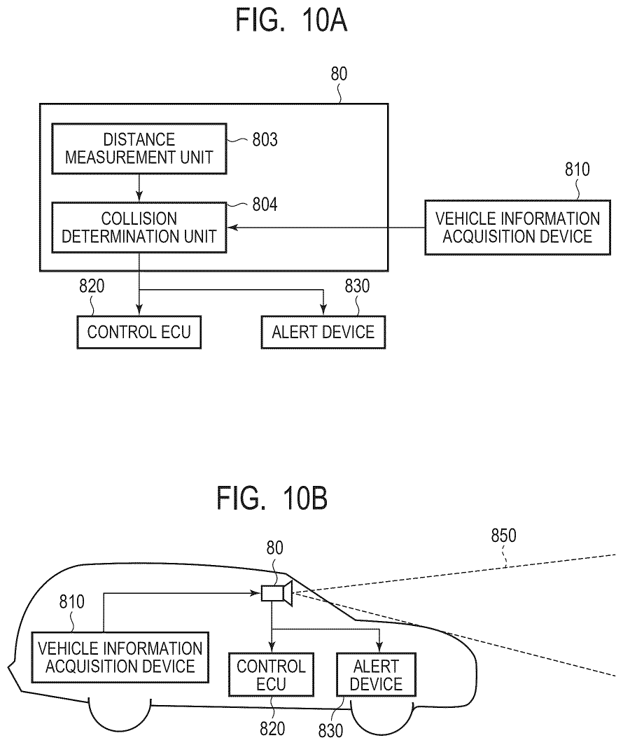

FIGS. 10A and 10B are block diagrams of equipment relating to an in-vehicle ranging device according to the present embodiment. Equipment 80 includes a distance measurement unit 803, which is an example of the ranging device of the above-described embodiments, and a signal processing device (processing device) that processes a signal from the distance measurement unit 803. The equipment 80 includes the distance measurement unit 803 that measures a distance to an object, and a collision determination unit 804 that determines whether or not there is a possibility of collision based on the measured distance. The distance measurement unit 803 is an example of a distance information acquisition unit that obtains distance information to the object. That is, the distance information is information on a distance to the object or the like. The collision determination unit 804 may determine the collision possibility using the distance information.

The equipment 80 is connected to a vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm, displaying alert information on a screen of a car navigation system or the like, or giving vibration to a seat belt or a steering wheel. These devices of the equipment 80 function as a movable body control unit that controls the operation of controlling the vehicle as described above.

In the present embodiment, ranging is performed in an area around the vehicle, for example, a front area or a rear area, by the equipment 80. FIG. 10B illustrates equipment when ranging is performed in the front area of the vehicle (ranging area 850). The vehicle information acquisition device 810 as a ranging control unit sends an instruction to the equipment 80 or the distance measurement unit 803 to perform the ranging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present invention is not limited to the above embodiments, and various modifications are possible. For example, an example in which some of the configurations of any one of the embodiments are added to other embodiments and an example in which some of the configurations of any one of the embodiments are replaced with some of the configurations of other embodiments are also embodiments of the present invention.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A≠B) is omitted. This is because it is assumed that “A is not B” is considered when “A is B” is described.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that any of the embodiments described above is merely an example of an embodiment for carrying out the present disclosure, and the technical scope of the present disclosure should not be construed as being limited by the embodiments. That is, the present disclosure can be implemented in various forms without departing from the technical idea or the main features thereof.

According to the present invention, the ranging device capable of improving ranging performance while implementing the eye safety is provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-069761, filed Apr. 23, 2024, which is hereby incorporated by reference herein in its entirety.

What is claimed is:

1. A ranging device comprising:
a light emitting element array in which a plurality of light emitting elements, each of which has variable light emission power, are two-dimensionally arranged;
a thinning control unit configured to perform thinned-out light emission control such that some of the plurality of light emitting elements emit light and the other light emitting elements do not emit light; and
a power control unit configured to control the light emission power of each of the plurality of light emitting elements such that light emission power per unit area does not exceed a threshold based on a first thinning rate indicating a proportion of the light emitting elements that do not emit light among the plurality of light emitting elements.

2. The ranging device according to claim 1, wherein the power control unit controls the light emission power such that the light emission power is increased as the first thinning rate is increased.

3. The ranging device according to claim 1, wherein each of the plurality of light emitting elements includes a laser light source.

4. The ranging device according to claim 1, wherein the power control unit controls the light emission power by controlling electric power supplied to each of the plurality of light emitting elements.

5. The ranging device according to claim 1, wherein the threshold is set so as to satisfy at least one of Class 1 of IEC 60825-1 of International Electrotechnical Commission, Class 1 of JIS C 6802 of Japanese Industrial Standards, and Class 1 of EN 60825-1 of European Standards.

6. The ranging device according to claim 1, further comprising a light receiving element array in which a plurality of light receiving elements, each of which generates a signal corresponding to incident light, are two-dimensionally arranged.

7. The ranging device according to claim 6, wherein the thinning control unit performs thinned-out light reception control to activate some of the plurality of light receiving elements and deactivate the other light receiving elements.

8. The ranging device according to claim 7, wherein the first thinning rate is equal to a second thinning rate indicating a proportion of the deactivated light receiving elements among the plurality of light receiving elements.

9. The ranging device according to claim 7, wherein the first thinning rate is different from a second thinning rate indicating a proportion of the deactivated light receiving elements among the plurality of light receiving elements.

10. The ranging device according to claim 6, wherein each of the plurality of light receiving elements counts a pulse corresponding to the incident light to generate a light reception count value.

11. The ranging device according to claim 6, wherein the thinning control unit determines the first thinning rate based on distance information from the ranging device to an object, the distance information being generated based on the signal output from the light receiving element.

12. The ranging device according to claim 11, wherein the power control unit controls the light emission power of each of the plurality of light emitting elements further based on the distance information.

13. The ranging device according to claim 6, wherein a light emitting range of one light emitting element corresponds to light receiving ranges of m light receiving elements, m being an integer of 2 or more.

14. The ranging device according to claim 13, wherein
the thinning control unit performs thinned-out light reception control to activate some of the plurality of light receiving elements and deactivate the other light receiving elements, and
the m light receiving elements corresponding to the light emitting element controlled to emit light by the thinned-out light emission control are all activated.

15. The ranging device according to claim 13, wherein
the thinning control unit performs thinned-out light reception control to activate some of the plurality of light receiving elements and deactivate the other light receiving elements, and
some of the m light receiving elements corresponding to the light emitting element controlled to emit light by the thinned-out light emission control are activated, and the others are deactivated.

16. The ranging device according to claim 6, wherein
a size of a light emitting range of one light emitting element and a size of a light receiving range of one light receiving element are different from each other, and
the light emitting range of one light emitting element includes the light receiving range of one light receiving element.

17. The ranging device according to claim 6, wherein a light receiving range of one light receiving element corresponds to light emitting ranges of n light emitting elements, n being an integer of 2 or more.

18. The ranging device according to claim 17, wherein
the thinning control unit performs thinned-out light reception control to activate some of the plurality of light receiving elements and deactivate the other light receiving elements, and
the n light emitting elements corresponding to one light receiving element to be activated are all controlled to emit light by the thinned-out light emission control.

19. A ranging device comprising:
a light emitting element array in which a plurality of light emitting elements, each of which has variable light emission power, are two-dimensionally arranged;
a thinning control unit configured to perform thinned-out light emission control such that some of the plurality of light emitting elements emit light and the other light emitting elements do not emit light; and
a power control unit configured to control the light emission power of each of the plurality of light emitting elements,
wherein the thinning control unit sets a first thinning rate indicating a proportion of the light emitting elements that do not emit light among the plurality of light emitting elements such that light emission power per unit area does not exceed a threshold based on light emission power of each of the plurality of light emitting elements.

20. A movable body comprising:
the ranging device according to claim 1; and
a movable body control unit configured to control the movable body based on distance information generated by the ranging device.
